(19) United States
(12) Patent Application Publication
(10) Pub. No.: US 2003/0125981 A1
(43) Pub. Date: Jul. 3, 2003

(54) Device, system and method for enforcing traffic regulations

(75) Inventor: Fernando Daniel Pedrazzoli Pazos, Madrid (ES)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 10/325,771

(22) Filed: Dec. 19, 2002

(30) Foreign Application Priority Data
Dec. 21, 2001 (EP) 01480140.1

(51) Int. Cl. G06F 17/60

(52) U.S. Cl. 705/1

(57) ABSTRACT

An electronic data processing portable device for assisting an appointed officer in enforcing traffic regulations comprises a user interface; means for capturing an electronic image of a vehicle; means for acquiring vehicle identification information of a vehicle contravening traffic regulations; means for determining a traffic regulation contravention type and a corresponding fine amount; a printer for printing and issuing a physical contravention notice; storage for contravention data comprising the identification information, the electronic image and the fine amount, and means for uploading the contravention data to a remote data processing center over a data communication channel.

### TECHNICAL FIELD

The present invention concerns a device, a system and a method for enforcing traffic regulations, in particular but not exclusively vehicle parking regulations.

### BACKGROUND ART

Nowadays, vehicle parking constitutes a major problem in urban areas. The increase in the number of circulating vehicles, the high density of population of many cities, and the necessity that many people have to commute to the same places for their day by day activities have led to a chronicle shortage of parking places.

The vehicle parking problem is just one aspect of the more complex problem of vehicle overcrowding.

To solve or at least limit this problem, municipal authorities are promoting a number of initiatives. Strengthening the public transportation infrastructures is presumably the best way to avoid vehicle overcrowding and, consequently, shortage of parking places. However, this kind of intervention requires high investments and time. Moreover, it takes time to educate people to renounce using their private vehicles in favor of public transport means. Other initiatives include the promotion of car pooling and of telecommuting.

Obviously, people would welcome an increase in the number of parking places, and in many cases municipal authorities have tried to adopt this policy. However, it is clear that the number of parking places cannot increase indefinitely. As a result, it has been long realized that vehicle parking must be somehow subject to regulation. For example, parking in some public areas is allowed for a limited time only, and in many cases subjected to the payment of an amount of money that can depend on the length of time that the vehicle is left parked.

Many ways are known to implement this kind of parking regulation. For example, parking meters are installed near each parking place. The parking meters have to be reset by drivers (normally under payment of a prescribed amount of money) upon leaving the vehicles. The parking meters measure the parking elapsed time and allow appointed personnel or police officers to check if the elapsed time exceeds the maximum allowed time.

In some cases, parking tag issuing machines are installed in parking areas, for issuing (normally under payment of a prescribed amount of money) parking tags indicating the vehicle arrival time, to be placed inside the parked vehicles so that they are visible from the outside, so as to enable appointed personnel or police officers to periodically check the elapsed parking time.

In payment-free parking areas, the indication of the vehicle arrival time can be obtained by means of arrival time indicators, installed inside the vehicles and visible from the outside, which the drivers must set upon leaving the vehicle so to allow appointed officers to periodically check the elapsed parking time. In some cases, such as free parking areas in front of public buildings, appointed persons manually place and periodically check marks (“tire chalks”) on the vehicles' tires for assessing the parking elapsed time.

A strict enforcement of this kind of time-limited parking regulations allows reducing the problem of parking place shortage, limiting overparking in crowded areas, and induces people to seek alternatives to private transportation means, thus contributing to reducing the problem of traffic in cities. Additionally, revenues from the application of fines to violators of the parking regulations allows accelerating the return on the substantial investments that municipal authorities make for implementing parking regulations.

Tickets for violations of the parking regulations (parking tickets) are typically issued manually by appointed police or traffic officers, usually in charge of the supervision of a specific area, for example on foot. These officers manually fill-in pre-printed form sheets, writing vehicle identification information, such as the vehicle type (brand, model), the license plate number, the location of the violation, the type of violation, and the amount of the fine to be paid by the violator. A notice of the detected violation, normally a copy of the filled-in form, is left on the violator's vehicle, while another copy is submitted at the end of the day or officer's working shift to a processing center (for example, the local or central police office). People at the processing center have to manually enter the information hand-written on the form into a computerized system that keeps track of the successful collection of the fine amount, and informs the responsible authorities of the necessity of prosecuting those violators who do not pay the fine in the prescribed time.

This kind of procedure, rather archaic, requires excessive human resources, takes excessive time and is prone to errors. In particular, delays and errors are caused by the manual filling of the pre-printed forms, the subsequent reading out of the filled-in forms by the personnel at the processing center, and the introduction of the read information into the computerized system. All these aspects lead to high costs involved in collection of the fines.

U.S. Pat. No. 6,081,206 discloses a parking regulation enforcement system intended to replace the above-mentioned manual “tire-chalking” process of enforcement of parking regulations. A video camera is mounted on a patrol car that is driven along a patrol route where vehicles are parked. The video camera captures a raster image of each vehicle along the patrol route, and a license plate recognition algorithm extracts a vehicle license plate number from the image. Each license plate number is time-tagged, geo-referenced and entered into a local database. When the patrol car retraces the patrol route after the posted time limit has expired, the database is searched to flag vehicles that were observed at the same location during the previous circuit and therefore in violation of the parking regulations. A parking citation is then printed, that the operator affixes to the offending vehicle.

The system disclosed in that document is only useful in the context of a specific type of parking areas, and cannot be applied in general.

U.S. Pat. No. 5,740,050 discloses a parking enforcement system comprising an electronic citation writing device adapted to communicate with intelligent, electronic parking meters. The electronic citation writing device receives from the electronic parking meter information including the meter status, the last payment received by the meter, time and date of payment. This information is used by the electronic citation writing device to print a citation.

A significant limitation of the system disclosed in that document is the fact that it can be adopted to enforce parking regulations only in parking areas equipped with intelligent parking meters.

### OBJECTS OF THE INVENTION

In view of the state of the art discussed, it has been an object of the present invention to make the process of applying and collecting fines more efficient, and thus less costly.

In particular, it has been an object of the present invention to reduce the errors inherent in the current practice of manually filling-in ticket forms.

Another object of the present invention has been to speed up and reduce the errors that, in the current practice, are inherent to the introduction of the ticket data into a computerised system.

According to the present invention, these and other objects have been attained by means of an electronic data processing portable device for assisting an appointed officer in enforcing traffic regulations as set forth in claim 1.

In brief, the device according to the present invention comprises:

user interface means for allowing the officer to interact with the device;

means for acquiring vehicle identification information of a vehicle contravening traffic regulations;

means for determining a traffic regulation contravention type and a corresponding applicable fine amount;

image capturing means for taking an electronic image of the contravening vehicle;

a printer for printing and issuing a physical contravention notice;

storage means for at least temporarily storing contravention data, said contravention data comprising the vehicle identification, the vehicle electronic image information and the fine amount, and

means for enabling the uploading of the contravention data stored in the storage means to a remote data processing center over a data communication channel.

Also according to the present invention, a system for enforcing traffic regulations is provided.

The system comprises at least one electronic data processing portable device according to the present invention, and at least one data processing center, for storing and processing contravention data received by the portable device over the data communication channel.

Still according to the present invention, a method for enforcing traffic regulations is provided.

Briefly stated, under the control of an electronic data processing portable device according to the present invention, operated by an appointed officer, vehicle identification information of a vehicle contravening traffic regulations is acquired, a traffic regulation contravention type is selected and a corresponding applicable fine amount is determined, an electronic image of the contravening vehicle is taken; a physical contravention notice is printed and issued. Contravention data, comprising the vehicle identification information, the vehicle electronic image and the fine amount, are at least temporarily stored in the device. The stored contravention data are then uploaded to a remote data processing center over a data communication channel.

The remote data processing center receives the contravention data from the remote portable device, stores the contravention data in a contravention database and processes the contravention data stored in the database.

### BRIEF DESCRIPTION OF THE DRAWINGS

The features and advantages of the present invention will be best understood with reference to the following detailed description together with the attached drawings, wherein:

FIG. 1 is a schematic view of a portable device according to an embodiment of the present invention, for assisting an appointed officer in enforcing violations of traffic regulations;

FIG. 2 schematically shows the portable device of FIG. 1 in terms of functional blocks;

FIG. 3 schematically shows content of a working memory of the portable device of FIGS. 1 and 2;

FIG. 4 schematically shows content of a permanent memory of the portable device of FIGS. 1 and 2;

FIGS. 5A and 5B are flowcharts illustrating the operation of the portable device of FIGS. 1 to 4;

FIG. 6 schematically shows a system according to an embodiment of the present invention, in which the portable device of FIGS. 1 to 5 may be used;

FIG. 7 schematically shows a database of a processing server of the system shown in FIG. 6; and

FIG. 8 is a flowchart illustrating the operation of the processing server.

### DETAILED DESCRIPTION OF THE INVENTION

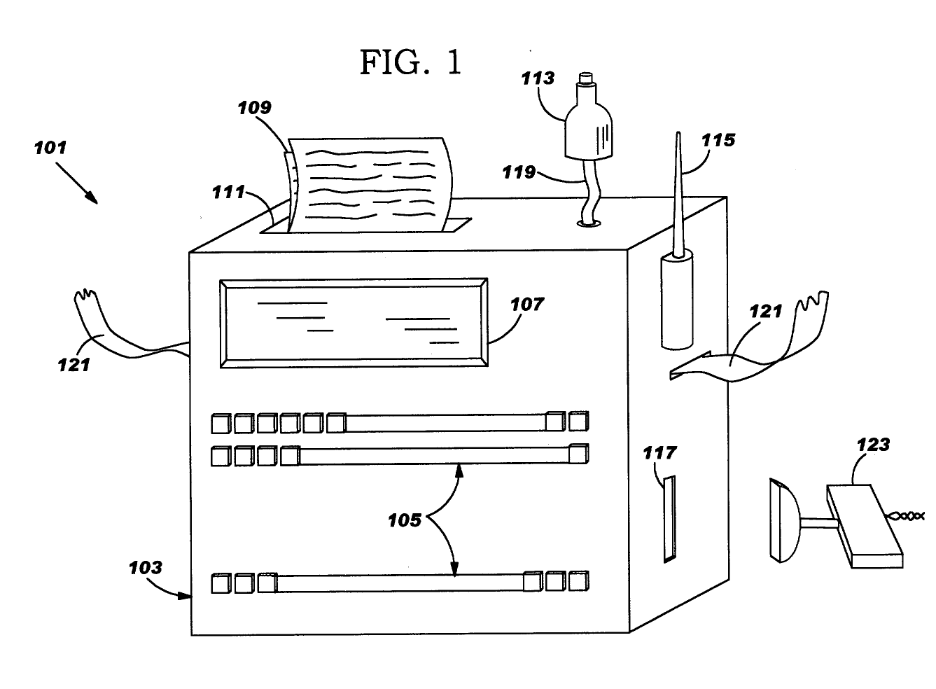

With reference to the drawings, FIG. 1 is a pictorial representation of an embodiment of a portable device for assisting an appointed officer in enforcing traffic regulations, particularly vehicle parking regulations. In particular the device allows automatically issuing tickets sanctioning violations to vehicle parking regulations. The portable device, identified as a whole by reference numeral 101, comprises a box-shaped casing 103 of relatively small dimensions, suitable for making the device 101 portable. The casing 103 houses a data input interface unit, such as a keyboard 105, through which the user of the device 101 can enter commands, data and, generally, interact with the device 101, and a display device 107, preferably a liquid crystal display (LCD), for displaying to the device's user relevant information, such as the data entered through the keyboard 105. Within the casing 103 (and thus not visible in the drawing) a small printer is housed, for printing physical contravention notices 109 when a violation to parking regulations is detected and sanctioned. The printer can for example be of the type embedded in POS or credit-card transaction devices, printing the notices in two identical copies on a double-sheet roll of paper. The printed notices are issued through an output slot 111 provided in the casing 103. Flexibly connected to the casing 103 through a cable 119 is an image capturing device 113, for example a digital still camera (DSC) or a digital video camera. In alternative, the image capturing device 113 can be embedded in the casing 103. The casing 103 can also house a receiver/transmitter (of which only an antenna 115 is visible in FIG. 1) for wireless communication with a remote processing center; the wireless receiver/transmitter can for example be of the type used in mobile phones, for enabling communication of the device 101 with the remote processing center over a cellular phone network. In addition, or in alternative to the wireless receiver/transmitter, the device 101 can communicate with the processing center via the plain old telephone network (POTN), connecting the device 101 to an external modem 123 through a communication port 117 (e.g., a standard RS-232 port). Alternatively, instead of the external modem, the device 101 can be connected to an external, stand-alone mobile phone. The casing 103 is preferably provided with a strap 121 for easy portability.

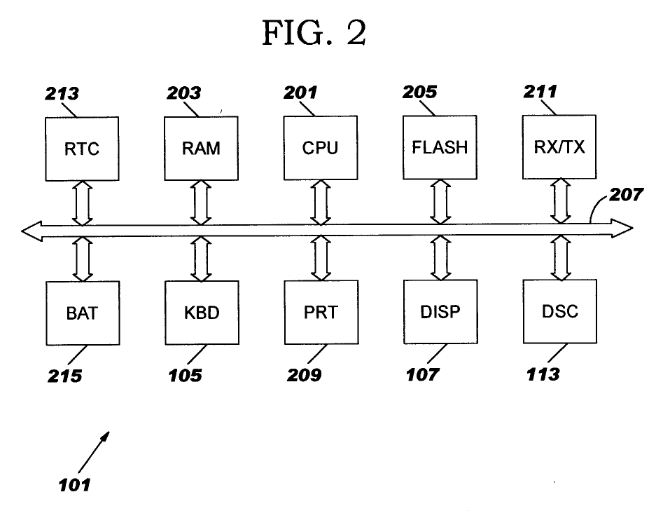

Referring now to FIG. 2, the main functional blocks of the device 101 are shown. The automatic ticket issuing device is a computerised apparatus, comprising a central processing unit (CPU) 201, typically a microprocessor, a working memory 203, typically a RAM, used by the CPU 201 for running programs and for temporarily storing data, a permanent memory 205, preferably an electrically erasable and programmable memory such as a Flash EPROM, for storing a device's bootstrap routine, as well as programs to be run by the CPU 201 and parking regulation violation data recorded by the device's user using the device 101. The CPU 201, the working memory 203 and the permanent memory 205 communicate with each other through a data communication bus 207. Also connected to the bus 207 are the keyboard (KBD) 105, the display device (DISP) 107, the image capturing device (e.g. the digital still camera DSC) 113, the printer 209, the receiver/transmitter (RX/TX) 211, as well as other peripheral units including a real time clock (RTC) 213 and a battery 215 supplying the power for operating the device 101.

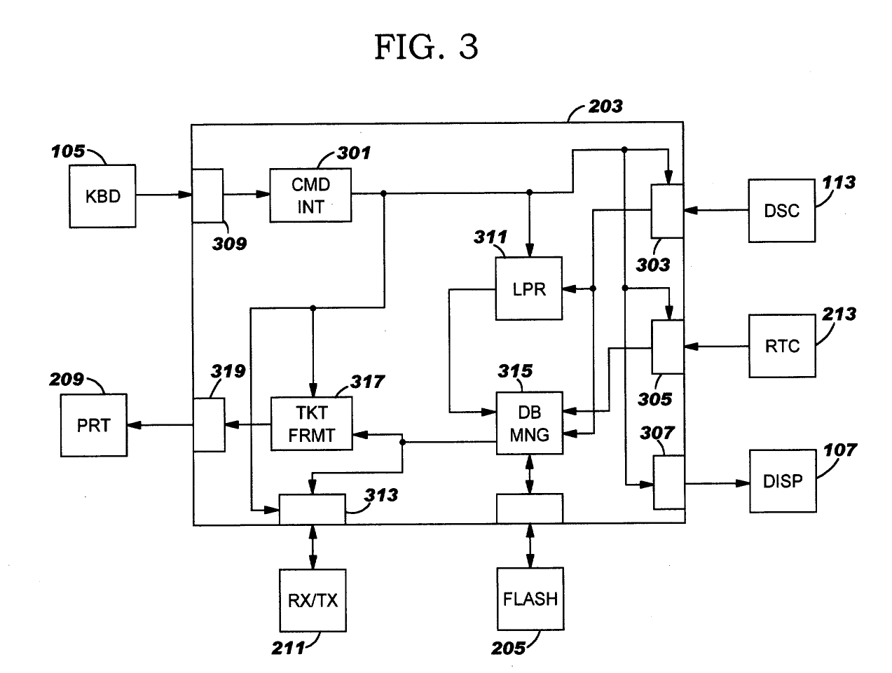

FIG. 3 shows schematically a partial content of the device's working memory 203 in operation. A command interpreter program module (in the following, for convenience, called a “command interpreter”) 301 receives, through a keyboard driver program module 309, commands and data entered by the device's user through the keyboard 105. The command interpreter 301 controls the image capturing device (DSC) 113 through a DSC driver program module 303, the RTC 213 through an RTC driver program module 305, the display device 107 through a display driver program module 307 and the receiver/transmitter 211 through a receiver/transmitter driver program module 313. A license plate number recognition (LPR) program module (“LPR module”) 311, substantially an optical character recognition (OCR) program module, receives through the DSC driver program module 303 electronic images of the contravening vehicle license plate, captured by the DSC 113, and determines from the captured images the vehicle license plate numbers by means of an OCR algorithm. A database manager program module 315 manages the storage and the retrieval of data into/from the permanent memory 205. A contravention notice formatter program module (“notice formatter”) 317, controlled by the command interpreter 301, manages the formatting of the data received from the database manager 315 into a prescribed notice format, and controls (through a printer driver program module 319) the printing of physical contravention notices by the printer 209.

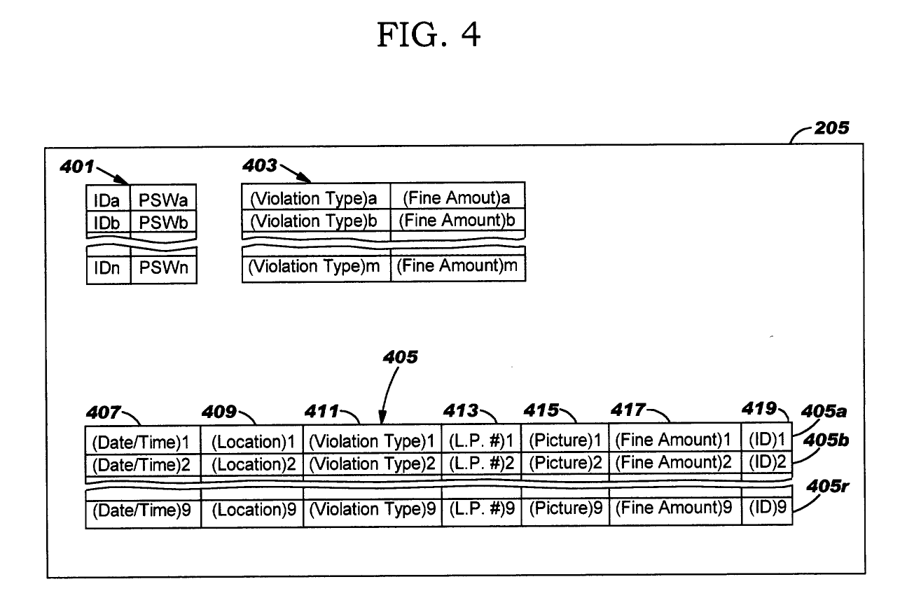

FIG. 4 pictorially shows a partial content of the permanent memory 205. Substantially, the memory 205 stores three databases: a first database 401 contains personal identification codes IDa-IDn of the officers authorized to the use of the device 101, together with respective passwords PSWa-PSWn. A second database 403 contains a list of possible parking violation types (VIOLATION TYPE)a-(VIOLATION TYPE)m that are to be sanctioned by a fine, together with the associated fine amounts (FINE AMOUNT)a-(FINE AMOUNT)m. The two databases 401 and 403 are resident in the device 101, and are for example downloaded from a computer of the processing center before putting the device 101 in operation. A third database 405, initially void, stores at least temporarily (i.e., at least until the content thereof is uploaded to the processing center computer) the data of the violations detected by the appointed officer using the device 101 and sanctioned with a corresponding fine. The third database is for example composed of records 405a-405r. A new record is added to the database 405 each time a new violation is detected and sanctioned. Each record include a field 407 in which the date and time the violation has been detected are stored; a field 409 in which the location where the violation has been committed is stored; a field 411 storing the type of violation contested; a field 413 storing the vehicle's license plate number; a field 415 containing an image file with the digital picture of the vehicle; a field 405 storing the fine amount corresponding to the violation type stored in the field 411; and a field 419 storing information (such as the personal identification code) identifying the officer who detected and sanctioned the violation.

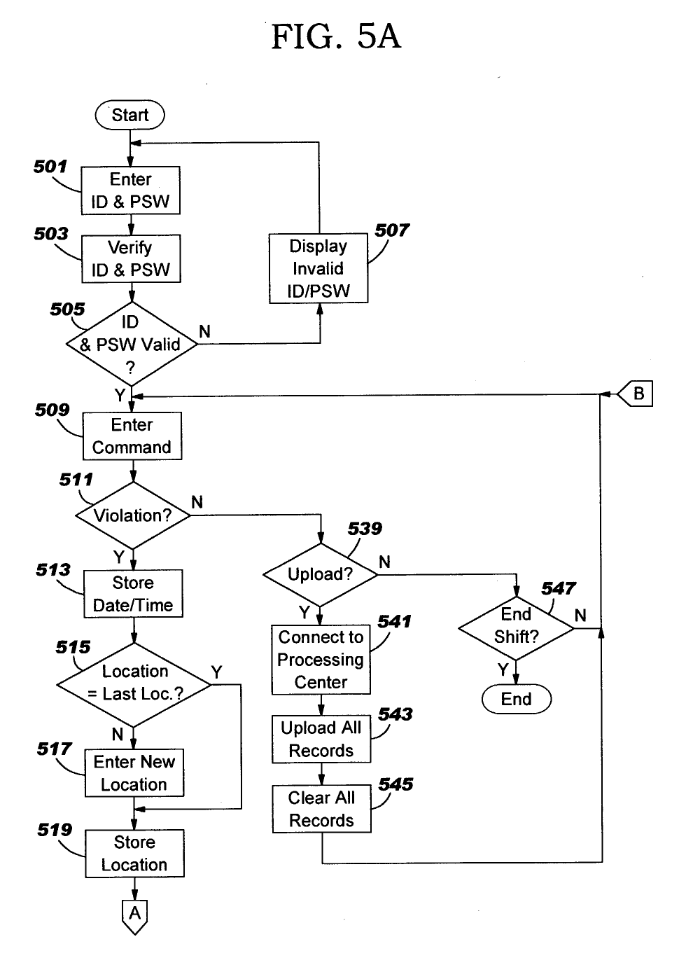

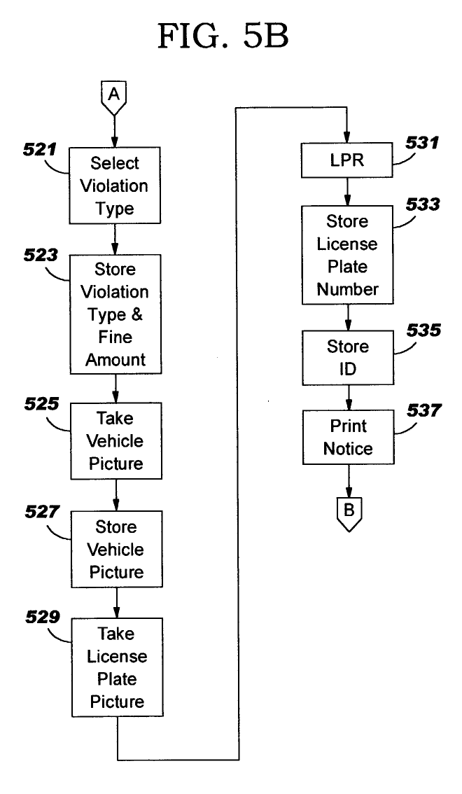

The operation of the portable automatic ticket issuing device 101 will be now described with the aid of the schematic flowcharts of FIGS. 5A and 5B. In order to use the device 101, an appointed officer enters a personal identification code and password: when turned on, the device 101 displays on the display 107 the request for entering the personal identification code and password, and waits for the personal identification code and password to be entered by the officer (block 501). When the personal identification code and password are entered, they are checked (block 503) to ascertain their validity (block 505). The command interpreter 301 reads the ID code and password entered by the officer through the keyboard 105 and, through the database manager 315, verifies that the entered ID code and password coincide with those stored in the database 401. If the check gives negative result, a message is displayed on the display 107 informing that the entered ID code and/or password are invalid (block 507), and the device 101 jumps back to block 501.

Once a valid ID code and password are entered, the user is recognised as authorised and the device 101 waits for a command to be entered by the user (block 509). The commands are entered by the user through the keyboard 105 and are interpreted by the command interpreter 301.

In particular, the user can enter a command for starting an automatic contravention notice issuing routine, or for uploading the data stored in the database 405 to a remote processing center, or for closing the device working session at the end of the officer's working shift.

When the officer, surveying the assigned area, detects a vehicle violating the parking regulations, the officer enters a command for launching the contravention notice issuing routine (block 511); the command is recognised by the command interpreter 301 and the violation notice issuing routine is started. Through the database manager 315, a new record 405a-405r is created in the database 405; the new record is void at the beginning. The current date and time are read from the RTC 213, and they are stored in the field 407 of the new record (block 513). Then, the officer is prompted (e.g., by a message appearing on the display 107) to enter the location (e.g., city, block, street, parking area) of the detected violation. The officer enters the location through the keyboard 105. Preferably, since an officer is normally assigned to a prescribed restricted area, the location need not to be entered each time a violation is detected; through the display 107 the device 101 asks the officer whether the location of the currently detected violation is the same as the last entered location (for example, the last entered location is stored temporarily in the working memory 203) (block 515). If the officer's reply is affirmative (branch Y at the exit of block 515) the temporarily-stored, last-entered location is stored (block 519) in the field 409 of the new record of the database 405; otherwise, the officer is prompted to enter the new location (block 517) through the keyboard 105, and the new location is stored in the field 409 of the new database record.

The officer is then prompted to select the detected violation type (block 521). The different violation types stored in the database 403 are displayed on the display 107, for example in succession. Using the keyboard 105, the officer can select the violation type that corresponds to the detected violation. Alternatively, the keyboard 105 may comprise dedicated keys each of which corresponds to a specific violation type. By striking one of these keys (which may be identified by labels describing the violation type associated with the key) the user selects a specific violation type. Once the violation type has been selected, it is stored in the field 411 of the new database record (block 523). At the same time, the corresponding fine amount, stored in the database 403, is retrieved from the database 403 and is stored in the field 417.

The officer is then prompted (by a message appearing on the display 107) to take a picture of the vehicle. The officer positions the digital still camera 113 and strikes a keyboard key (either a dedicated key or any of the keyboard keys) to take the picture (block 525). The picture taken by the digital still camera 113 has the form of an image file (for example, in JPEG format). The image file obtained from the digital still camera 113 is then stored in the field 415 of the new database record (block 527).

The officer is then prompted (by a message appearing on the display 107) to take a picture of the vehicle's license plate (block 529). The officer positions the digital still camera 113 in front of the vehicle license plate, in a position and at a distance such that detail of the license plate can be captured, then strikes a keyboard key and the picture is taken. The image file obtained is then passed to the LPR module 311, which performs an optical character recognition and determines the license plate number from the captured image (block 531). The license plate number is then stored in the field 413 of the new database record (block 533). It should be observed that, in principle, it is not strictly necessary to take two different pictures of the vehicle: one picture only could be taken, provided that the single picture allows at the same time recognizing the vehicle and determining the license plate number by means of optical character recognition. Alternatively, the license plate number can be entered manually by the officer, using the keyboard 105.

The database record is then completed by automatically storing in the field 419 the ID code of the officer (block 535).

Once the new database record has been completed, a physical contravention notice is printed, to be left on the contravening vehicle (block 537). The notice formatter module 317 retrieves the data from the database 405, through the database manager 315, formats the data into a printable form, and passes the formatted data to the printer 209. The paper notice is printed, preferably in two copies, and it is left by the officer on the vehicle. The notice will be used by the violator to settle the fine. The data printed on the contravention notice includes for example the date and time the violation was detected, the violation location, the vehicle's license plate number, the fine amount to be paid and the officer's ID code.

With this step, the automatic contravention notice issuing routine ends, and the device 101 jumps back to block 509, waiting for a new command to be entered.

Periodically, for example at the end of his/her working shift, the officer has to upload the content of the database 405 to the server computer of the local processing center. To this purpose, the officer enters a command for starting the upload procedure (block 539). The command is interpreted by the command interpreter 301, and a connection is established to the local processing center (block 541) via the receiver/transmitter 211. Alternatively, the officer may connect the device 101 to the external modem 123 connected to the POTN, or to an external mobile phone. The data stored in the database 405 are retrieved by the database manager module 315 and passed to the receiver/transmitter 211 for the transmission to the processing center server computer (block 543). Once the processing center server computer acknowledges the correct receipt of the data, the database 405 can be cleared (block 545). The device 101 jumps back to block 509.

At the end of his/her working shift, the officer closes the device working session by entering a prescribed command (block 547).

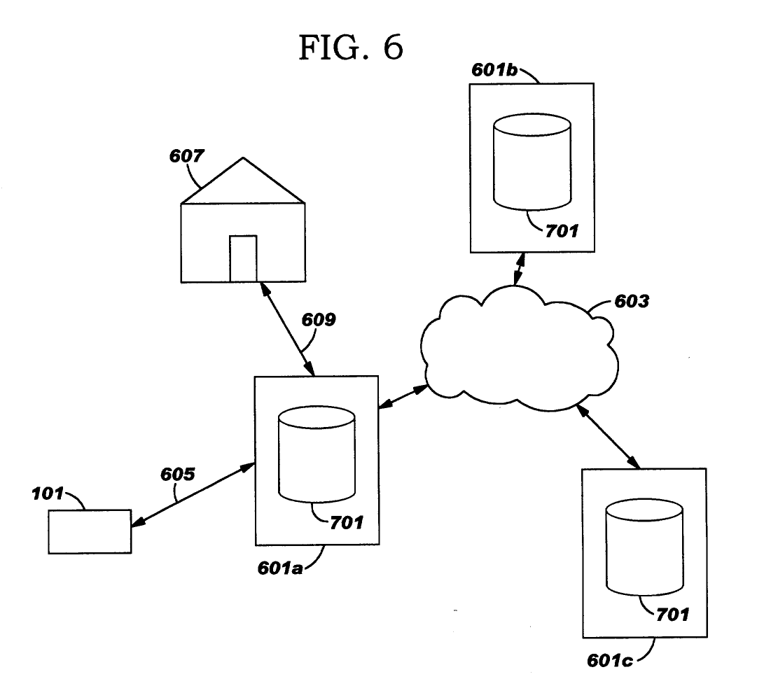

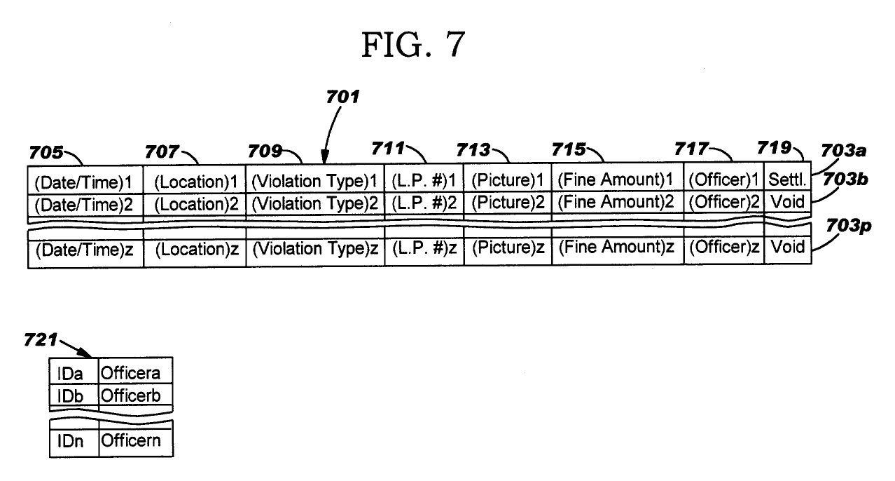

FIG. 6 schematically shows a system of processing centers, comprising a plurality of (three in the shown example) local data processing centers 601a, 601b, 601c, distributed in the same urban area. Each data processing center comprises one or more computers, of adequate computing power, as well as data communication means such as modems or wireless receivers/transmitters, for enabling communication with the remote portable devices 101. The different local data processing centers communicate with each other through a data communication network 603, for example a private data communication network (e.g., a WAN), the POTN, an open data communication network such as the Internet. When an appointed officer ends his/her working shift, a connection 605 is established between the officer's device 101 and the local data processing center (in the example, the data processing center 601a). As mentioned previously, the connection 605 can be for example a wireless connection, or a connection over the plain old telephone network, or a connection through a cellular phone network. The data stored in the database 405 of the device 101 are thus uploaded to the local data processing center 601a, and stored in a database at the local data processing center, schematically shown in FIG. 7 and identified as a whole by 701. The database 701 comprises a plurality of records 703a, 703b, . . . , 703p, each one relating to a detected and sanctioned violation. Each record 703a, 703b, . . . , 703p comprises a field 705 in which the date and time the violation has been detected are stored; a field 707 in which the location where the violation has been committed is stored; a field 709 storing the type of violation contested; a field 711 storing the vehicle's license plate number; a field 713 containing an image file with the digital picture of the vehicle; a field 715 storing the fine amount corresponding to the violation type stored in the field 709; a field 717 storing the name of the officer who detected and sanctioned the violation, and a flag field 719 indicating whether the fine has been already paid or not yet paid. Each local data processing center manages a database such as the database 701; alternatively, the database 701 may be common to all the local data processing centers, and is for example resident in one of the data processing centers.

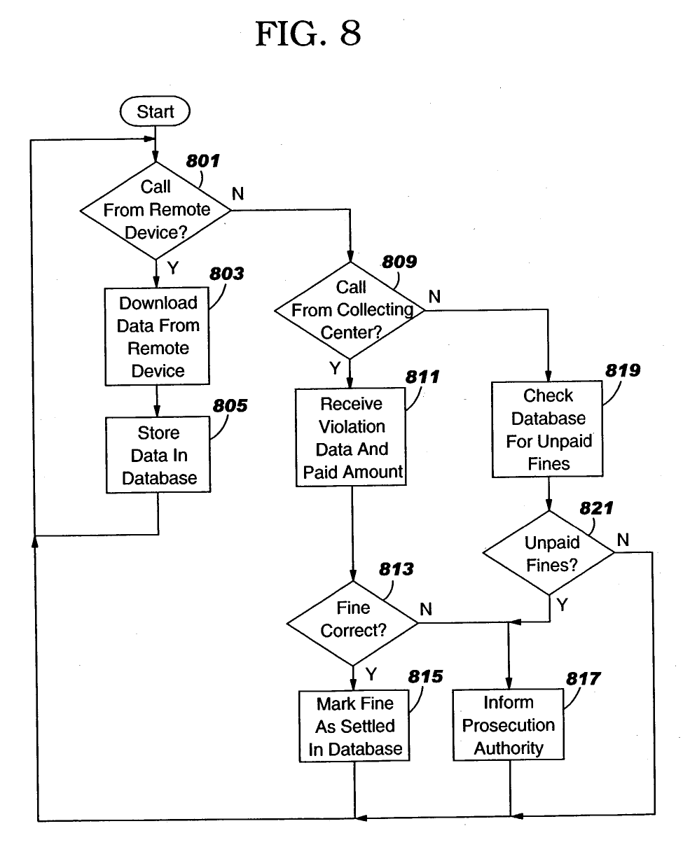

The operation of the processing center is schematically depicted in the flowchart of FIG. 8. When the local data processing center 601a receives a call from a portable device 101 (block 801), the data processing center 601a downloads the data stored in the permanent memory 205 of the calling device 101 (block 803) and stores the received data in the database 701 (block 805). The device 101 transmits the data stored in the respective database 405 record by record. For each received record, a new record is created in the database 701 of the data processing center 601a, and the content of the fields 407 to 417 of the received record is copied into the fields 705 to 715 of the newly created record of the database 701. Concerning the field 717, on the basis of the content of the received field 419 (containing the identification code of the appointed officer) the local data processing center searches a table 721 in which there is stored, for each identification code IDa to IDn, the name of the officer. The field 719 is initially left void. When all the records in the database 405 of the calling device 101 have been downloaded, the data processing center jumps back to block 801.

To settle the fine, the vehicles' owners go to a fine collecting center, identified by 607 in FIG. 6. The fine collecting center can be a bank office, a post office, a police station, or an entrusted fine collecting agency. Although FIG. 6 shows only one fine collecting center for simplicity, a plurality of fine collecting centers may be provided, distributed in the urban area. The physical notice left by the officer who detected and sanctioned the contravention is presented by the vehicle's owner to the fine collecting center, and the fine amount is paid to the fine collecting center, either by cash, credit card or debit card. The contravention data printed on the physical contravention notice presented by the vehicle's owner are recorded at the fine collecting center, and a fine settlement receipt is returned to the vehicle's owner (such a receipt may be one of the two copies of the physical contravention notice, marked as settled).

When the fine has been settled, the fine collecting center 607 calls the data processing center 601a, or any one of the data processing centers 601a-601c to communicate the settlement of the fine. Connection between the fine collecting center 607 and the data processing center 601a is established over a data communication network 609, such as the plain old telephone network, a private network (such as a WAN), an open data communication network such as the Internet. Referring again to FIG. 8, when the data processing center receives a call from the fine collecting center 607 (block 809), the contravention data and the amount paid by the vehicle's owner are received from the fine collecting center (block 811). The data processing center 601a looks through the database 701 to identify the record 703a-703p relating to the allegedly settled contravention, and checks if the paid amount corresponds to the-fine amount stored in the field 715 of the contravention record (block 813). Each contravention is for example univocally identified by a contravention code ID-DDMMYYhhmmss, made up of the officer's ID code, the date the violation has been detected (day DD, month MM, year YY) and the time (hour hh, minute mm, second ss) the contravention has been detected; the contravention code may be printed on the physical contravention notice left on the vehicle. If the amount paid corresponds to the fine amount stored in the field 715 of the contravention record, the contravention is marked as settled by setting the flag in the field 719 of the contravention record (block 815). If the amount paid does not correspond to the fine amount, the flag in the field 719 is not set, and the data processing center informs an authority entrusted with the contravention prosecution (block 817).

On a periodic basis (for example, day-by-day) the data processing center checks the contraventions stored in the database 701 (block 819) for ensuring that the fines are paid within a prescribed time limit from the date the contraventions have been sanctioned (block 821). The contraventions which are not settled within the prescribed time limit are communicated to the prosecution authority (block 817). The vehicle's electronic image file stored in the database field 713 is used if necessary by the prosecution authority as evidence of the committed violation.

Thanks to the present invention, notices for parking regulation contravention are issued in a more efficient way.

In particular, problems caused by difficult legibility of hand-written data are overcome.

By using the portable device according to the present invention, the time needed to issue a contravention notice is reduced. The enforcement officers can thus exploit the saved time for covering wider areas, and a reduction of personnel can be attained.

At the end of his/her working shift, the appointed enforcement officer needs not personally go to the data processing center: the data of the contraventions detected and sanctioned by the officer during the working shift are simply uploaded from the portable device to the remote data processing center. The uploaded data are automatically entered in the data processing center, so that no personnel is required to manually enter the contravention data in the data processing center computers.

The present invention provides a device and a system useful for assisting appointed officers in enforcing parking regulation violations. Every kind of violation to parking regulations, in any kind of parking area can be sanctioned by using the device and system according to the present invention.

More generally, the device and system according to the present invention are also suitable for enforcing other kinds of violations to the traffic regulations, in particular violations committed by stationary vehicles, such as stopping at red lights and pedestrian crossing areas.

Although the present invention has been disclosed and described by way of an embodiment, it will be apparent to those skilled in the art that several modifications to the described embodiment, as well as other embodiments of the present invention are possible without departing from the scope thereof as defined in the appended claims.

For example, the portable device may comprise different or additional user interfaces, such as a vocal interface (comprising a voice synthesiser and a loudspeaker for providing vocal messages to the device's user, and a microphone and a voice recognition program module through which the device's user can enter commands and data), a pointing device for allowing the device's user to select items displayed on the display device, or an optical pen. The device's internal data communication bus may comply with one of the standards adopted in the personal computer industry, such as the USB, and the image capturing device may be for example a low-cost, commercially available web-cam connectable to the device through a standard USB port.

What is claimed is:

1. An electronic data processing portable device for assisting an appointed officer in enforcing traffic regulations, the device comprising:
user interface means for allowing the officer to interact with the device;
means for acquiring vehicle identification information of a vehicle contravening traffic regulations;
means for determining a traffic regulation contravention type and a corresponding applicable fine amount;
image capturing means for taking an electronic image of the contravening vehicle;
a printer for printing and issuing a physical contravention notice;
storage means for at least temporarily storing contravention data, said contravention data comprising the vehicle identification information, the fine amount, and the electronic image, and
means for enabling uploading of the contravention data stored in the storage means to a remote data processing center over a data communication channel.

2. The device according to claim 1, further comprising means for acquiring a contravention location, to be stored in the storage means as part of the contravention data.

3. The device according to claim 1, in which said means for acquiring the vehicle identification information comprises means for automatically acquiring vehicle identification data.

4. The device according to claim 3, in which said means for automatically acquiring the vehicle identification data comprises the image capturing means, and optical character recognition means for obtaining a vehicle license plate number from a vehicle license plate image taken by said image capturing means.

5. The device according to claim 1, in which said means for acquiring the vehicle identification information comprises the user interface means, used by the appointed officer to enter vehicle identification data.

6. The device according to claim 1, in which said means for determining the traffic regulation contravention type and the corresponding applicable fine amount comprises, stored in the storage means, a database of possible contravention types and corresponding fines, the device automatically determining the applicable fine upon selection by the appointed officer, through the user interface means, of an applicable contravention type from the database of contravention types.

7. The device according to claim 1, in which said means for enabling uploading of the contravention data comprises wireless data transmission means.

8. The device according to claim 1, in which said means for enabling uploading of the contravention data comprises means for connecting the device to an external data transmission device.

9. An electronic data processing portable device for assisting an appointed officer in enforcing traffic regulations, the device comprising:
an input/output user interface through which the officer interacts with the device;
an electronic image capturing device for taking an electronic image of a contravening vehicle;
an optical character recognition software module for obtaining vehicle identification information from the electronic image;
a database of traffic regulation contravention types and corresponding applicable fine amounts;
a printer for printing and issuing a physical contravention notice;
a storage device in which contravention data are stored, said contravention data comprising the vehicle identification information, the fine amount, and the vehicle electronic image, and
means for enabling uploading of the contravention data stored in the storage means to a remote data processing center over a data communication channel.

10. The device according to claim 9, in which said means for enabling uploading of the contravention data comprises wireless data transmission means.

11. The device according to claim 9, in which said means for enabling uploading of the contravention data comprises means for connecting the device to an external data transmission device.

12. A system for enforcing traffic regulations, comprising:
at least one electronic data processing portable device, the electronic data processing device comprising:
user interface means for allowing an officer to interact with the device;
means for acquiring vehicle identification information of a vehicle contravening traffic regulations;
means for determining a traffic regulation contravention type and a corresponding applicable fine amount;
image capturing means for taking an electronic image of the contravening vehicle;
a printer for printing and issuing a physical contravention notice;
storage means for storing contravention data, said contravention data comprising the vehicle identification information, the fine amount, and the electronic image, and
means for enabling uploading of the contravention data stored in the storage means to a remote data processing center over a data communication channel;
at least one data processing center, for storing and processing contravention data received from the portable device over the data communication channel.

13. A method of enforcing traffic regulations, comprising:
under the control of an electronic data processing portable device operated by an appointed officer:
acquiring vehicle identification information of a vehicle contravening traffic regulations;
acquiring an electronic image of the contravening vehicle;
determining a traffic regulation contravention type and a corresponding applicable fine amount;
printing and issuing a physical contravention notice;
at least temporarily storing in the device contravention data, said contravention data comprising the vehicle identification information, the fine amount, and the electronic image, and
uploading the stored contravention data to a remote data processing center over a data communication channel;
under the control of the remote data processing center:
receiving the contravention data from the portable device;
storing the contravention data in a contravention database;
processing the contravention data stored in the database.

14. The method according to claim 13, further comprising:
under the control of the portable device, acquiring information defining a contravention location, and storing the information defining the contravention location information with the contravention data.

15. The method according to claim 13, in which the step of acquiring the vehicle identification information comprises taking an electronic image of a license plate of the contravening vehicle and performing an optical character recognition on the electronic image of the license plate for obtaining a vehicle license plate number.

16. The method according to claim 13, in which said step of acquiring vehicle identification information comprises inputting in the portable device identification data manually by the appointed officer.

17. The method according to claim 13, in which said step of determining the traffic regulation contravention type and the corresponding applicable fine amount comprises:
providing in the portable device a database of possible contravention types and corresponding applicable fine amounts;
presenting to the appointed officer the possible contravention types and, responsive to a contravention type selected by the appointed officer, automatically determining the applicable fine.
